(19) United States
(12) Patent Application Publication
(10) Pub. No.: US 2012/0094820 A1
(43) Pub. Date: Apr. 19, 2012

(54) PAPER PRESSING MACHINE FOR SCULPTURED PATTERN

(76) Inventor: Faye Angevine, Taiwan (CN)

(21) Appl. No.: 13/142,087

(22) PCT Filed: Oct. 9, 2009
(86) PCT No.: PCT/CN09/01119

§ 371 Date: Nov. 14, 2011

(30) Foreign Application Priority Data
Oct. 7, 2008 (CN) 200820136624.6

(51) Int. Cl. B31B 1/62

(52) U.S. Cl. 493/467

(57) ABSTRACT

A paper pressing machine for sculptured pattern comprises a bottom plastic sheet (1) and a top plastic sheet (2) where connection sides (13,23) of plastic sheets are connected with each other to form a hinge structure, and multiple pairs of small plastic sheets (3,4), each of which composes of a convex plastic sheet (3) and a concave plastic sheet (4). The interconnecting inner surfaces of convex plastic sheets (3) and concave plastic sheets (4) are provided with convexes (31) and concaves (41) respectively, which could be jogged with each other. Inner surfaces of the bottom plastic sheet (1) and the top plastic sheet (2) are formed with multiple small holes (11). Other surfaces of the small plastic sheets (3,4) are formed with multiple convex columns (32) which insert into the small holes (11) for location.

### TECHNICAL FIELD

The present invention relates to a paper pressing device for patterns, particularly relates to a hinged paper pressing device for relief sculptured patterns which can be used for free combination of patterns (DIY).

### PRIOR ART

The traditional paper-cut crafts are appreciated by many people. With diverse and ever-changing styles, as well as great value in art appreciation, they are very suitable for elementary education for children, and such paper-cut patterns have been widely used in children's education abroad. For example, in the United States, products with such paper-cut patterns are very popular. Generally, paper, plastic sheets, rubber sheets or similar materials are cut into models such as letters, cartoons, animals, or human-like patterns and etc. to develop children's ability of cognition and discrimination, However the efficiency is relatively low and the consistency of patterns is poor if the traditional manual paper-cutting approach is used to produce the products with such paper-cat patterns, so that this approach is not suitable for mass production. In order to overcome such disadvantages, a method for mass production is used, i.e. pattern cutters which can process and cut into patterns in advance, such as “hinged paper pressing device for relief sculptured patterns” disclosed in a Chinese utility model patent under Patent No. 200620058230.4 is one of such kind of pattern cutters. Since enter into the market, the hinged paper pressing device for relief sculptured patterns has been in hot pursuit by the consumers, but such products are unable to meet the demands for customers who want to compress large patterns due to their fixed sizes, and because the pattern on the paper pressing device for patterns has been fixed, the selection of patterns by the consumers on their own cannot be fulfilled.

### DISCLOSE OF THE INVENTION

The objective of the present invention is to provide a hinged paper pressing device for relief sculptured patterns which can be used for free combination of patterns (DIY). Such paper pressing device not only retains all advantages of original paper pressing device, and the consumers can also select multiple pairs of small plastic sheets with different patterns base on their needs, and insert them into small holes on large plastic sheets to form paper pressing devices with different sizes and different patterns, used for compression on paper (or card).

The objective of the present invention comes into reality in a way that a hinged paper pressing device for relief sculptured patterns which can be used for free combination of patterns comprises a bottom plastic sheet and a top plastic. sheet as well as multiple pairs of small plastic sheets, and the connecting edges of said bottom plastic sheet and top plastic sheet are connected with each other to form a hinge structure. The said hinged paper pressing device for relief sculptured patterns which can be used for free combination of patterns, wherein the interconnecting inner surfaces of bottom plastic sheet and top plastic sheet are provided with multiple small holes for location, and convex columns on the connecting edges of bottom plastic sheet and through-holes on the connecting edges of top plastic sheet interconnected with it are provided, and the convex columns and through-holes are jogged together to form a hinge so that two plastic sheets can be opened and closed freely.

The said hinged paper pressing device for relief sculptured patterns which can be used for free combination of patterns, wherein the connecting edges of bottom plastic sheet and top plastic sheet are connected with each other to form a hinge structure via a thin plastic sheet.

The said hinged paper pressing device for relief sculptured patterns which can be used for free combination of patterns has a convex plastic sheet and a concave plastic sheet in each pair of small plastic sheets. The interconnecting inner surfaces of convex plastic sheet and concave plastic sheet and the corresponding site on concave plastic sheet are provided with convexes and concaves respectively, which could be jogged with each other, and the contours of convexes and concaves could be processed to be blank-holders of compressible patterns. The other side of each pair of small plastic sheet is provided with convex columns, which are used for small holes for insertion of bottom plastic sheet and top plastic sheet.

The said hinged paper pressing device for relief sculptured patterns which can be used for free combination of patterns, wherein there is a gap of 0.5-1 mm located between the connecting edges of bottom plastic sheet and top plastic sheet.

### BRIEF DESCRIPTION OF THE DRAWINGS

FIG. 1 is a schematic diagram illustrating the structure of the present invention.

FIG. 2 is a structural diagram of bottom plastic sheet in the present invention.

FIG. 3 is B-B cutaway view for FIG. 2.

FIG. 4 is a structural diagram of top plastic sheet in the present invention.

FIG. 5 is A-A cutaway view for FIG. 4.

FIG. 6 is a structural diagram of convex plastic sheet in small plastic sheets.

FIG. 7 is right view for FIG. 6.

FIG. 8 is a structural diagram of concave plastic sheet in small plastic sheets.

FIG. 9 is right view for FIG. 8.

FIG. 10 is a schematic diagram for combination of top plastic sheet and bottom plastic sheet.

FIG. 11 is a schematic diagram illustrating a pair of small plastic sheets is inserted into top plastic sheet and bottom plastic sheet respectively.

FIG. 12 is a schematic diagram illustrating insertion of entire patterns into top plastic sheet and bottom plastic sheet.

FIG. 13-FIG. 15 arc schematic diagrams illustrating usage status of the present invention.

FIG. 16 shows the patterns compressed by using the present invention.

FIG. 17-1-FIG. 17-4 are schematic diagrams illustrating insertion of paper into the present invention from different directions.

FIG. 18-1 is a schematic diagram illustrating another connecting mode between top plastic sheet and bottom plastic sheet.

FIG. 18-2 is A-A cutaway view for FIG. 18-1.

FIG. 18-3 is a schematic diagram illustrating enlarged part B in FIG. 18-2.

Description of symbols for components

| | | | |
|---|---|---|---|
| 1. Bottom plastic | 11. Small hole | 12. Convex | 13. Connecting |
| sheet | | column | edge |
| 2. Top plastic | 22. Through-hole | 23. Connecting | 24. Thin plastic |
| sheet | | edge | sheet |
| 3. Convex plastic | 31. Convex | 32. Convex | |
| sheet | | column | |
| 4. Bottom plastic | 41. Concave | | |
| sheet | | | |
| 5. Paper (or card) | | | |
| 6. Gap | | | |

### PREFERRED EMBODIMENTS OF THE PRESENT INVENTION

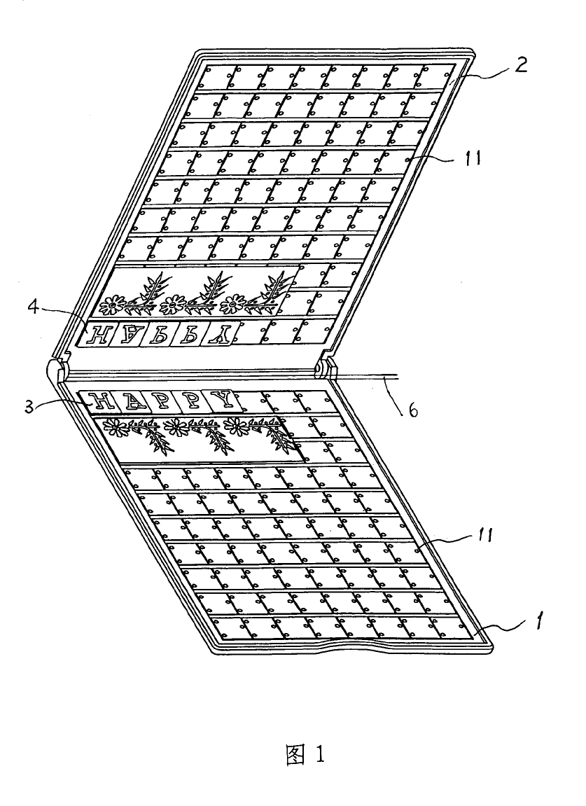

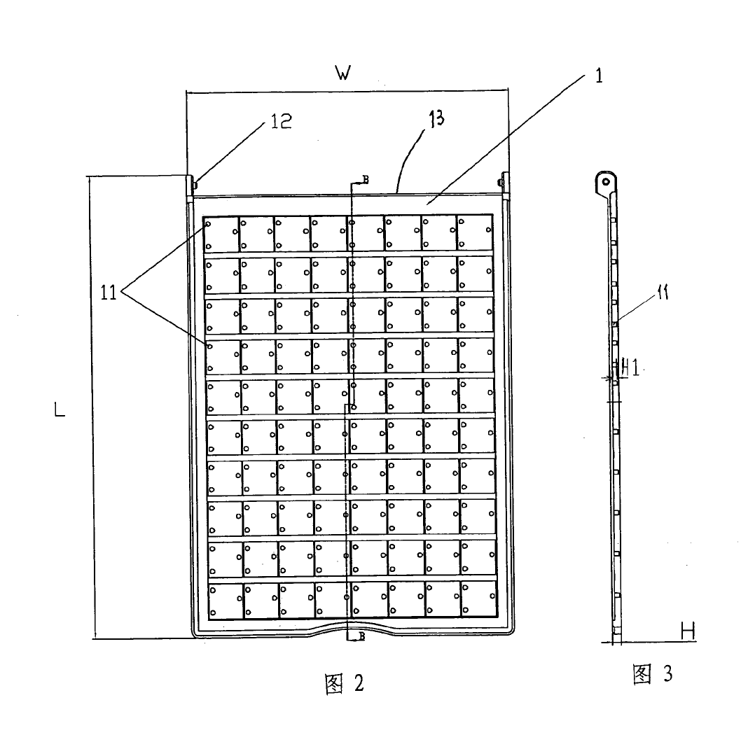

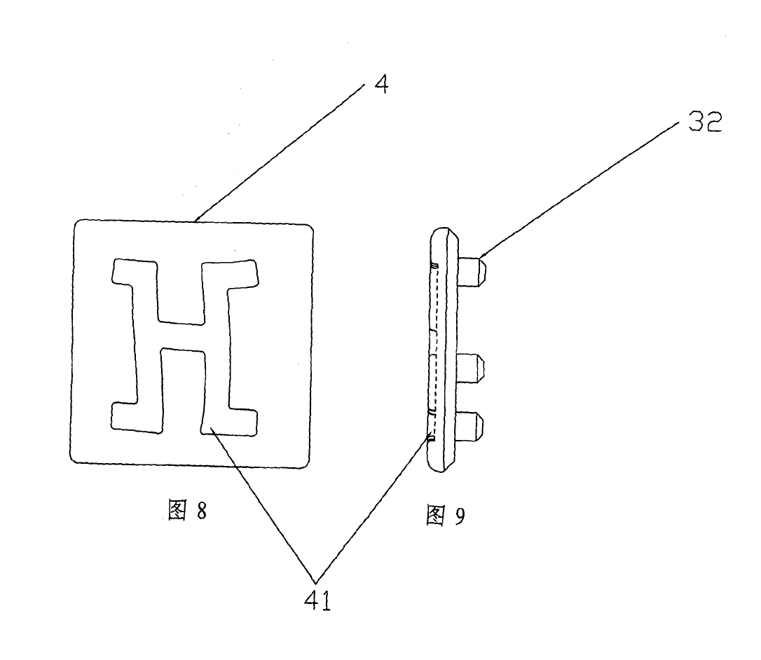

As shown in FIG. 1-FIG. 5, the hinged paper pressing device for relief sculptured patterns which can be used for free combination of patterns comprises a bottom plastic sheet (1) and a top plastic sheet as well as multiple pairs of small plastic sheets, and the connecting edges (13, 23) of said bottom plastic sheet (1) and top plastic sheet (2) are connected with each other to form a hinge structure. The said hinged paper pressing device for relief sculptured patterns which can be used for free combination of patterns, wherein the interconnecting inner surfaces of bottom plastic sheet (1) and top plastic sheet (2) is provided with multiple small holes (11) for location, and convex columns (11) on the connecting edge (13) of bottom plastic sheet (1) and through-holes (22) on the connecting edge (23) of top plastic sheet (2) interconnected with it are provided, and the convex columns (12) and through-holes (22) are jogged together to form a hinge so that two plastic sheets (1, 2) can be opened and closed freely.

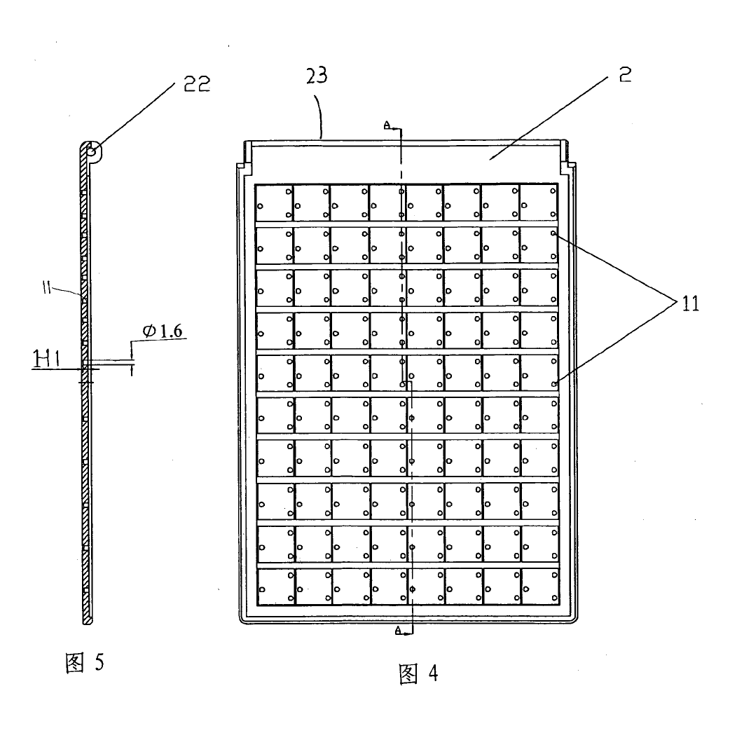

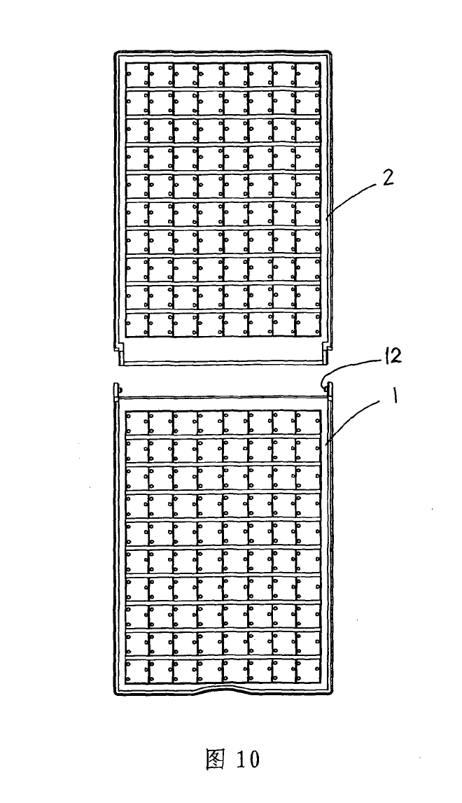

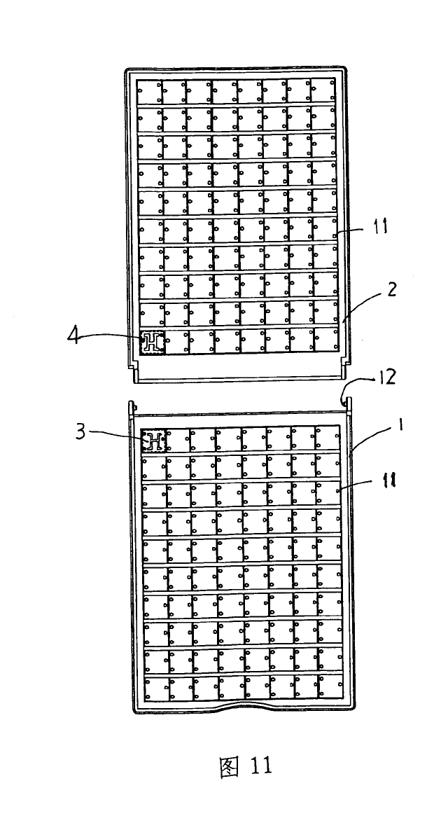

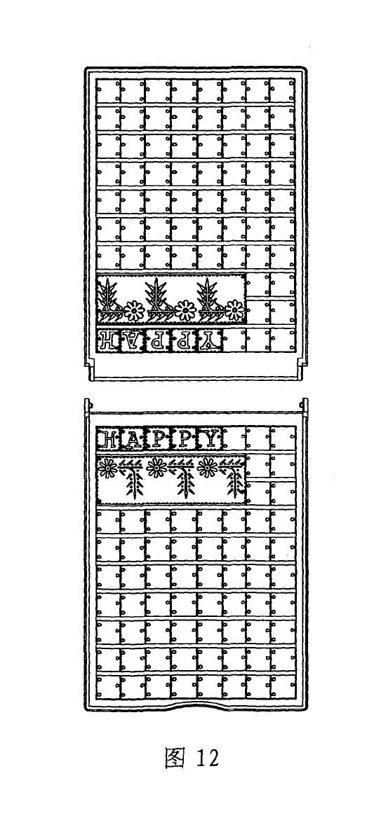

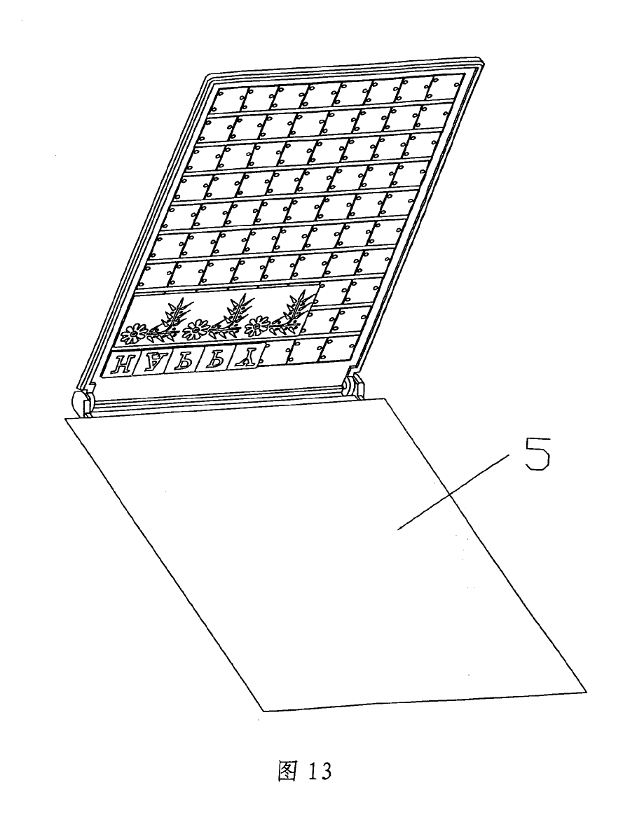

As shown in FIG. 18-1-FIG. 18-3, they are schematic diagrams illustrating another connecting mode between bottom plastic sheet (1) and top plastic sheet (2), wherein the hinge structure by which bottom plastic sheet (1) and top plastic sheet (2) connect with each other is that the connecting edges (13, 23) of bottom plastic sheet (1) and top plastic sheet (2) are connected with each other via a thin plastic sheet (24), as shown in FIG. 18-3, which becomes thinner and thinner from outside to inside in order to facilitate folding.

As shown in FIG. 6-FIG. 9, each pair of small plastic sheet comprises of a convex plastic sheet (3) and a concave plastic sheet (4). The interconnecting inner surfaces of convex plastic sheet (3) and concave plastic sheet (4) and the corresponding site on concave plastic sheet (4) are provided with convexes (31) and concaves (11) respectively, which could be jogged with each other, and the contours of convexes (41) and concaves (31) could be processed to be blank-holders of compressible patterns. The other side of each pair of small plastic sheet is provided with convex columns (32), which are used for small holes (11) for insertion of bottom plastic sheet (1) and top plastic sheet (2).

The sizes of bottom plastic sheet (1) and top plastic sheet (2) of the hinged paper pressing device for relief sculptured patterns which can be used for free combination of patterns can be. determined as necessary, typically width (W)×length (L): 4×6-8×12 mm, and their thickness H is 1-4 mm. The diameter and depth H1 of each small hole (11) are 1.6 mm and 0.8-3.8 mm respectively. When the hinge structure located between bottom plastic sheet (1) and top plastic sheet (2) via connecting edges (13, 23) is closed, the sites of small holes (11) on their inner surfaces align with each other.

For each of multiple small plastic sheets, the thickness H′ is 1.5 mm, and the number of convex columns (32) on its surface is 2-4. The height H2 and diameter of convex columns (32) are 1.5-3.5 mm and 1.5 mm respectively. The convex columns (32) are fit with a gap of 0.1 mm located between the small holes on bottom plastic sheet (1) and top plastic sheet (2). The said hinged paper pressing device for relief sculptured patterns which can be freely combined. wherein there is a gap (6) of 0.5-1 mm located between the connecting edges (13, 23) of bottom plastic sheet (1) and top plastic sheet (2). With this gap (6), paper can be inserted into the hinged paper pressing device for relief sculptured patterns which can be freely combined from four directions for compression on paper.

The materials of bottom plastic sheet, top plastic sheet, convex plastic sheet and concave plastic sheet in the present invention can be plastic materials such as PE, PS, PVC, PP, ABS and etc.

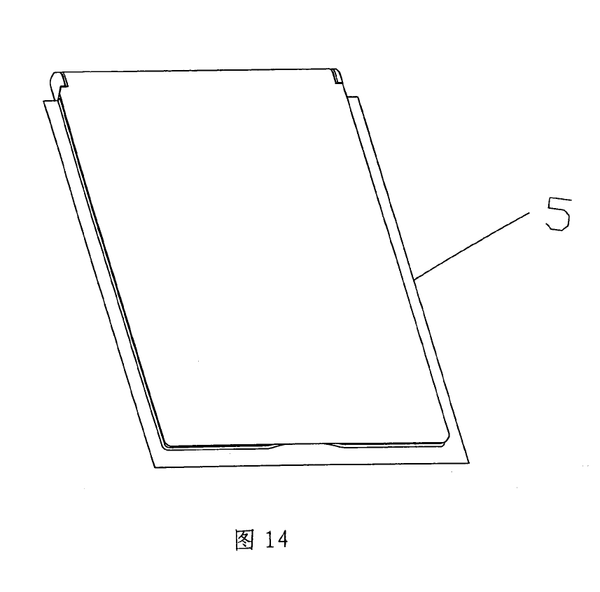

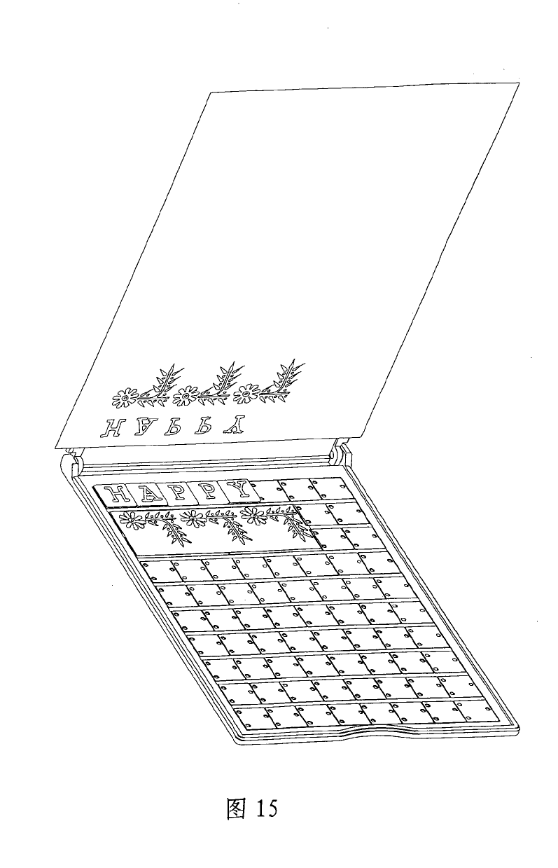

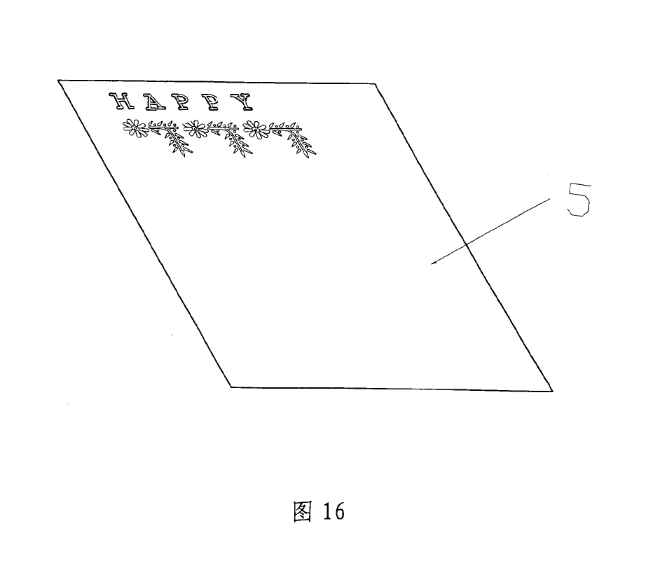

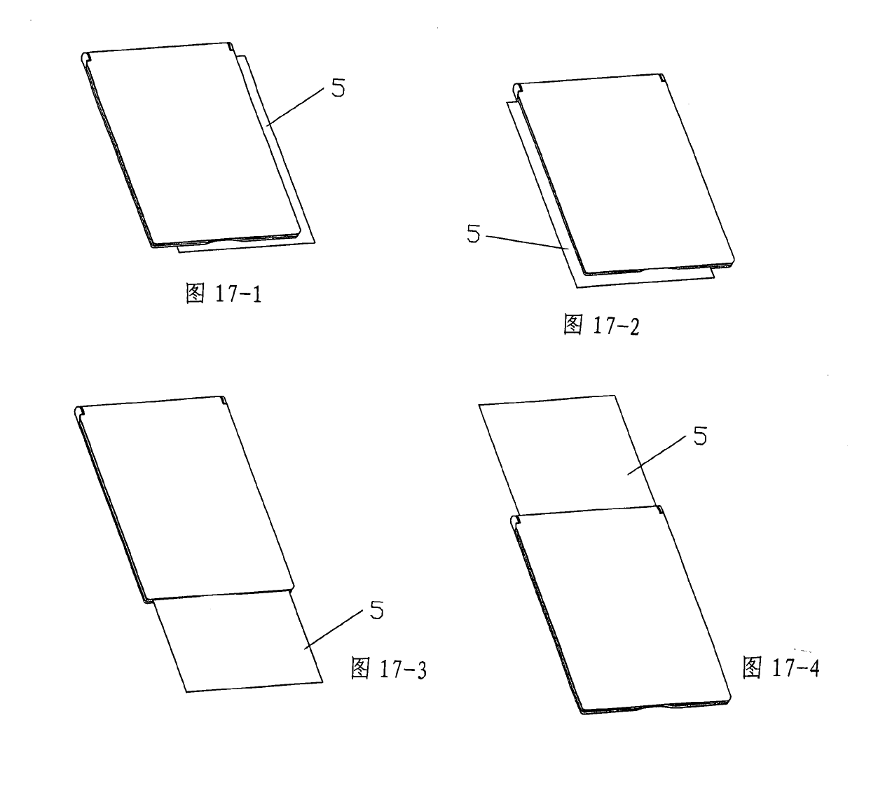

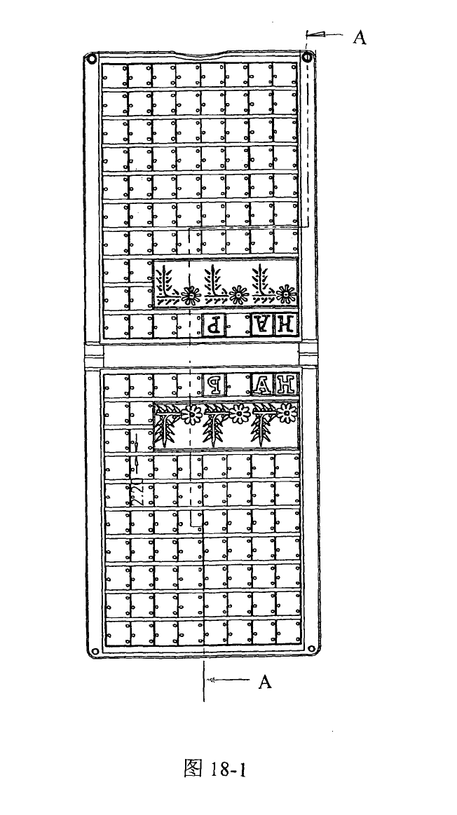

The process for use of the present invention is shown as follows:
1. Open bottom plastic sheet (1) and top plastic sheet (2), and make the small holes (11) on the plastic sheets upright as shown in FIG. 11.
2. Insert the selected a pair of small plastic sheets (letters or patterns) such as convex plastic sheet (3) with letter “H” into the selected site on bottom plastic sheet (1) with character upright; on the opposite side, insert concave plastic sheet (4) of this pair of small plastic sheets into its mirrored site on top plastic sheet (2) with character upright as shown in FIG. 11.
3. As the last step, insert the entire word (HAPPY) and sonic patterns into bottom plastic sheet (1) and top plastic sheet (2) as shown in FIG. 12.
4. And then put the though-hole (22) on the top of top plastic sheet (2) onto the convex column (12) on the top of bottom plastic sheet (1) to form a hinge as shown in FIG. 13.
5. Put the paper (or card) to be compressed on the middle of between two plastic sheets (1, 2) as shown in FIG. 13.
6. Close bottom plastic sheet (1) and top plastic sheet (2) together, exert a force onto top plastic sheet (2) and make concave (41) on concave plastic sheet on the inner surface of top plastic sheet (2) and convex column (31) to be jogged with each other to compress the paper (or card) as shown in FIG. 14.
7. Open bottom plastic sheet (1) and top plastic sheet (2), and the paper (or card) (5) located between two plastic sheets is compressed into shape and attached onto concave plastic sheet (4) on inner surface of top plastic sheet (2) as shown in FIG. 15.
8. Simply separate and take out the paper (or card) (5) and concave plastic sheet (4) on inner surface of top plastic sheet (2) to get a product with compressed patterns whose contour shape and style is in accord with designed patterns in the plastic sheets as shown in FIG. 16.

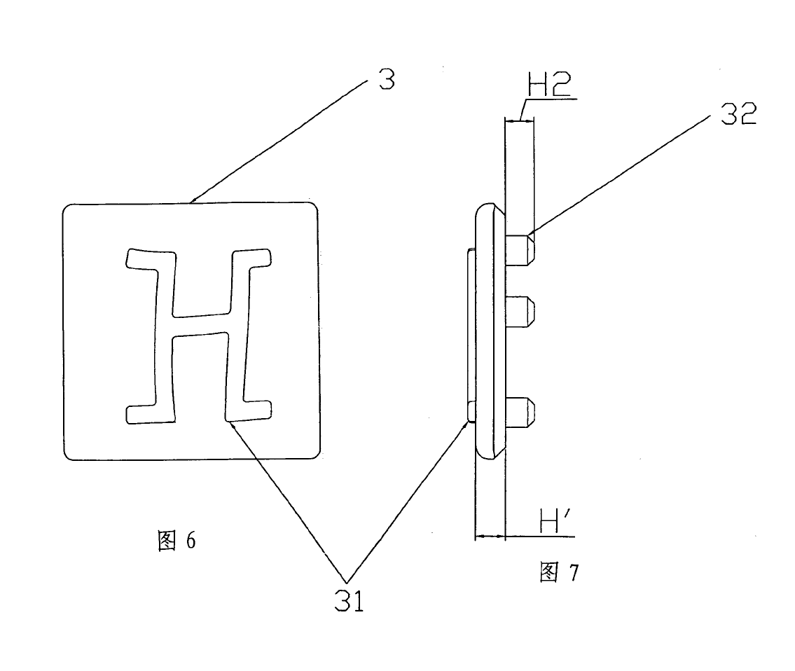

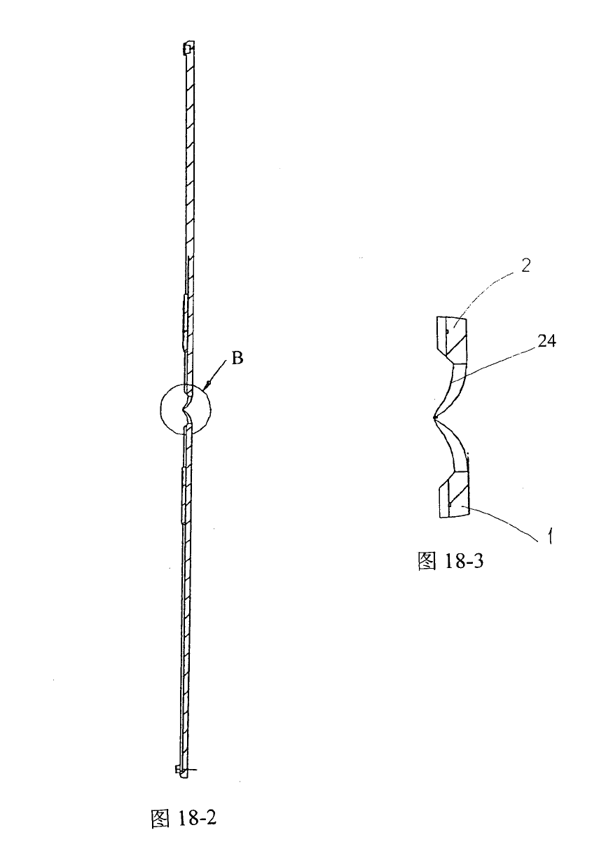

In addition, the said hinged paper pressing device for relief sculptured patterns which can be freely combined wherein there is a gap (6) of 0.5-1 mm located between the connecting edges (13, 23) of bottom plastic sheet (1) and top plastic sheet (2). With this gap (6), when a consumer wants to compress the bottom of paper (or card) (5), this paper (or card) (5) can be inserted into from top of the hinged paper pressing device of the present invention as shown in FIG. 17-4 so that the use range of directions of card's opening is thus extended as shown in FIG. 17-1-FIG. 17-4, making insertion of paper (or card) (5) from four directions for compression on the paper (or card) (5) into a reality.

### INDUSTRIAL APPLICABILITY

The advantages of the present invention are including: simple and reasonable structure, easy production, low cost, and very easy to use; the consumers can select several sets of small plastic sheets with different patterns base on their needs to form paper pressing devices with different sizes and different patterns, used for compression on paper (or card); vivid paper patterns with stereoscopic impression and clearly demarcated layers can be produced. In addition, with this invention, paper can be inserted from four directions, and when a consumer wants to compress the bottom of card, the card can be inserted into from the top of this paper pressing device so that the use range of directions of card's opening is thus extended.

1-10. (canceled)

11. A hinged paper pressing device for creating relief sculptured patterns which can be used for creating a free combination of patterns, comprising:
a bottom plastic sheet having a generally planar inner face and a connecting edge at a first end;
a top plastic sheet having a generally planar inner face and a connecting edge at a first end, the connecting edges of the bottom plastic sheet and the top plastic sheet being connected to each other with a hinge structure and the generally planar inner faces of the bottom plastic sheet and top plastic sheet disposed facing each other when the hinge structure is in a dosed position; and
a plurality of pairs of smaller plastic sheets selectively attachable to the inner faces at various locations of the top and bottom plastic sheets so that each pair will align with one another when the hinge structure is in a dosed position, each pair comprising a first plastic sheet and a corresponding second plastic sheet, the first plastic sheet having a raised pattern disposed upon a top surface thereof and the second plastic sheet having a corresponding recessed pattern formed in a top surface thereof corresponding to the raised pattern on the first plastic sheet, such that the raised pattern can be at least partially inserted into the recessed pattern to create a compressible relief sculptured pattern when a sheer of paper is pressed between the first and second plastic sheets.

12. The hinged paper pressing device for relief sculptured patterns of claim 11, wherein the generally planar inner faces of the bottom plastic sheet and the top plastic sheet each comprise multiple sets of small holes for the selective attachment of the pairs of smaller plastic sheets thereto.

13. The hinged paper pressing device for relief sculptured patterns of claim 12, wherein the multiple sets of small holes on the generally planar inner faces of the bottom plastic sheet and the top plastic sheet are arranged such that when the hinge structure is closed, the multiple sets of small holes on the inner faces of the bottom plastic sheet and top plastic sheet align with each other.

14. The hinged paper pressing device for relief sculptured patterns of claim 12, wherein hinge structure further comprises at least a first column disposed on the top plastic sheet which is inserted into a through hole disposed on the bottom plastic sheet to connect the top plastic sheet to the bottom plastic sheet with the generally planar inner faces of the bottom plastic sheet and top plastic sheet disposed facing each other when the hinge structure is in a closed position.

15. The hinged paper pressing device for relief sculptured patterns of claim 12, wherein the hinge structure comprises a thin plastic sheet attached to the connecting edges of bottom plastic sheet and top plastic sheet which becomes thinner from each connecting edge towards the center in order to facilitate folding.

16. The hinged paper pressing device for relief sculptured patterns of claim 12, wherein each of the first and second plastic sheets further comprise at least one column disposed on a second surface thereof opposite the first surface thereof for selective insertion into the small holes disposed on the generally planar inner face of the bottom plastic sheet or top plastic sheet for removable attachment of the first and second plastic sheets thereto.

17. The hinged paper pressing device for relief sculptured patterns of claim 16, wherein paper can be inserted from four directions for compression on paper by using the hinged paper pressing device for relief sculptured patterns.

18. The hinged paper pressing device for relief sculptured patterns of claim 12, wherein the bottom plastic sheet and top plastic sheet each further comprises a surface of a sidewall disposed on the inner face thereof along at least two edges of an area in which the multiple sets of small holes are arranged.

19. The hinged paper pressing device for relief sculptured patterns of claim 18, wherein the plurality of pairs of smaller plastic sheets are further characterized in that the first surface of the each smaller plastic sheet of a pair align in a common plane with a surface of the sidewall disposed on the inner face of the bottom plastic sheet or top plastic sheet in which the smaller plastic sheet is inserted.

20. The hinged paper pressing device for relief sculptured patterns of claim 18, wherein a rotation point of the hinge structure aligns in a common plane with a surface of the sidewall disposed on the inner face of the bottom plastic sheet and an inner surface of the sidewall disposed on the top plastic sheet.

21. The hinged paper pressing device for relief sculptured patterns of claim 12, wherein a generally planar outer face of the top plastic sheet and a generally planar outer face of the bottom plastic sheet can align with one another in a common plane when the hinge structure is rotated to an open position.

22. The hinged paper pressing device for relief sculptured patterns of claim 11, wherein the bottom plastic sheet, top plastic sheet and multiple pairs of small plastic sheets are formed from plastic materials selected from the group comprising PE, PS, PVC, PP, and ABS.

23. A method of forming a relief sculptured pattern in a sheet of paper, the method comprising:
opening a hinged paper pressing device for creating relief sculptured patterns which comprises
a bottom plastic sheet having a generally planar inner face and a connecting edge at a first end,
a top plastic sheet having a generally planar inner face and a connecting edge at a first end, the connecting edges of the bottom plastic sheet and the top plastic sheet being connected to each other with a hinge structure and the generally planar inner faces of the bottom plastic sheet and top plastic sheet disposed facing each other when the hinge structure is in a closed position,
removably attaching at least a first pair of smaller plastic sheets to the generally planar inner faces of the bottom plastic sheet and top plastic sheet, each pair comprising a positive pattern plastic sheet and a corresponding negative pattern plastic sheet, with a first surface of each of the pair parallel to the respective planar inner face such that upon closure of the hinge structure a raised pattern disposed on a first surface of the positive pattern plastic sheet will be at least partially inserted into a recessed pattern formed in a first surface of the negative plastic sheet which corresponds to the raised pattern on the positive plastic sheet;
placing a sheet of paper between the at least a first pair of smaller plastic sheets upon closure of the hinge structure;
closing the hinge structure to bring the generally planar inner faces towards one another; and
compressing the paper between the bottom plastic sheet and top plastic sheet to compress the paper between the pairs of smaller plastic sheets disposed thereon, thereby forming the relief sculptured pattern in the sheet of paper corresponding to the raised and recessed pattern.

24. The method of claim 23, wherein opening a hinged paper pressing device for creating relief sculptured patterns comprises opening the device such that the generally planar inner faces of the bottom plastic sheet and top plastic sheet face upright.

25. The method of claim 23, wherein removably attaching at least a first pair of smaller plastic sheets to the generally planar inner faces of the bottom plastic sheet and top plastic sheet comprises inserting columns disposed on a second surface of each smaller plastic sheet opposite the first surface thereof into one set of multiple sets of small holes disposed on the generally planar inner faces for the removable attachment of the pairs of smaller plastic sheets thereto.

26. The method of claim 25, wherein closing the hinge structure to bring the generally planar inner faces towards one another causes the multiple sets of small holes on the inner faces of the bottom plastic sheet and top plastic sheet to align with each other.

27. The method of claim 23, wherein removably attaching at least a first pair of smaller plastic sheets to the generally planar inner faces of the bottom plastic sheet and top plastic sheet comprises removably attaching the at least first pair of plastic sheets such that the first surface of the each smaller plastic sheet of a pair align in a corn ion plane with a surface of a sidewall disposed on the inner face of the bottom plastic sheet or top plastic sheet to which the smaller plastic sheet is removably attached.

28. The method of claim 27, wherein opening a hinged paper pressing device for creating relief sculptured patterns comprises rotating the hinge structure to until a generally planar outer face of the top plastic sheet and a generally planar outer face of the bottom plastic sheet align with one another in a co n non plane.

29. The method of claim 23, wherein closing the hinge structure to bring the generally planar inner faces towards one another further comprises inserting a set of columns disposed near the connecting edge of the top plastic sheet into a corresponding set of through holes disposed near the connecting edge of the tip plastic sheet to form a hinge structure.

30. The method of claim 23, wherein closing the hinge structure to bring the generally planar inner faces towards one another further comprises folding a thin plastic sheet disposed between the connecting edges of bottom plastic sheet and top plastic sheet which forms a hinge structure which becomes thinner in diameter along its length from each connecting edge towards the center.

31. The method of claim 23, wherein placing a sheet of paper where it will be between the at least a first pair of smaller plastic sheets upon closure of the hinge structure comprises inserting the paper into a gap between the connecting edges of the bottom sheet and top plastic sheet.

32. The method of claim 23, further comprising removably attaching a plurality of pairs of smaller plastic sheets to the generally planar inner faces of the bottom plastic sheet and top plastic sheet, each pair comprising a positive pattern plastic sheet and a corresponding negative pattern plastic sheet, with a first surface of each of the pair parallel to the respective planar inner face such that upon closure of the hinge structure the raised patterns disposed on positive pattern plastic sheets can be at least partially inserted into the corresponding recessed patterns formed in the negative pattern plastic sheets to emboss a sheet of paper disposed therein between.
